(19) United States
(12) Patent Application Publication
(10) Pub. No.: US 2011/0108597 A1
(43) Pub. Date: May 12, 2011

(54) Support System

(76) Inventors: Henning Kunow, Rheinsberg (DE); Gaute Solaas, Austin, TX (US)

(21) Appl. No.: 12/904,671

(22) Filed: Oct. 14, 2010

(30) Foreign Application Priority Data
Nov. 6, 2009 (FR) 20093295

(51) Int. Cl. A45F 3/00; B23P 17/04

(52) U.S. Cl. 224/660; 29/428

(57) ABSTRACT

Methods and systems of supporting various devices may include a support arm having a middle section and a plurality of arm ends configured to extend from the middle section to define an inverted V-shaped geometry. A hip brace can be configured to be couple to the plurality of arm ends, and a fastening arrangement may be configured to be couple to the middle section of the support arm.

### BACKGROUND

1. Technical Field

Embodiments of the present invention generally relate to a system for supporting various devices such as tools or instruments, wherein the devices are carried by and operated by a human.

2. Discussion

Currently, many instruments and tools that are carried by an operator in the field include a carrying harness having a simple shoulder strap to support the instrument, wherein the strap may provide some freedom for the user to operate the instrument with the hands. Such arrangements can have a drawback in that the full weight of the instrument is transferred to the shoulder and neck of the user. In the long run, such a solution may be tiresome for the user. In addition, straps and webs may hinder free movement of the arms.

Many musical instruments, particularly wind instruments such as saxophones, clarinets and horns, are used without any supportive arrangement. Accordingly, the user must both carry the instrument and operate it with his/her hands and does not have the full freedom to concentrate on playing the instrument. Also, this approach may prevent the user from breathing freely. There is therefore a need for an improved arrangement for supporting tools and instruments that may be easier to use and provide a greater freedom for the user.

### BRIEF SUMMARY

Embodiments may provide for an apparatus including a support arm having a middle section and a plurality of arm ends configured to extend from the middle section to define an inverted V-shaped geometry. The apparatus can also include a hip brace configured to be coupled to the plurality of arm ends, and a fastening arrangement configured to be coupled to the middle section of the support arm.

Embodiments can also involve an apparatus including a device and a support arm. The support arm may have a middle section and a plurality of arm ends configured to extend from the middle section to define an inverted V-shaped geometry. The apparatus can also include a hip brace configured to be coupled to the plurality of arm ends, and a fastening arrangement configured to be coupled to the middle section of the support arm and to the device. If mounted to an individual, the support arm and the hip brace may support the device from a hip region of the individual.

Other embodiments may include a method of assembling an apparatus in which a hip brace is coupled to a plurality of arm ends of a support arm, wherein the plurality of arm ends extend from a middle section of the support arm to define an inverted V-shaped geometry. The method can also involve coupling a fastening arrangement to the middle section of the support arm.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a diagram of an example a support brace in use with a musical instrument according to an embodiment;

FIGS. 2A and 2B are perspective views of an example of a support brace having a hook and string configuration with pockets according to an embodiment;

FIGS. 3A-3D are perspective views of an example of a support brace having a hook and string configuration with bolts according to an embodiment;

FIGS. 4A-4C are perspective views of an example of a support brace having a tray according to an embodiment; and

FIG. 5 is a diagram of an example of the support brace shown in FIGS. 4A-4C in use according to embodiments.

### DETAILED DESCRIPTION

In particular, embodiments of the invention include a system for supporting a device configured to be operated by a user, wherein the system may include the following components: A support brace adapted to be worn by the user resting on the user's hips, wherein the support brace is shaped as a loop spanning the greater part of a circle and with two ends, a support arm shaped as an inverted “V” with two ends, the support arm being adapted to be mounted on the brace with its two ends connected to corresponding ends on the support brace, and a fastening arrangement adapted to connect the device to the top of the support arm. The fastening arrangement may be a string hooked onto the support arm near the bottom of the V and tied to the device.

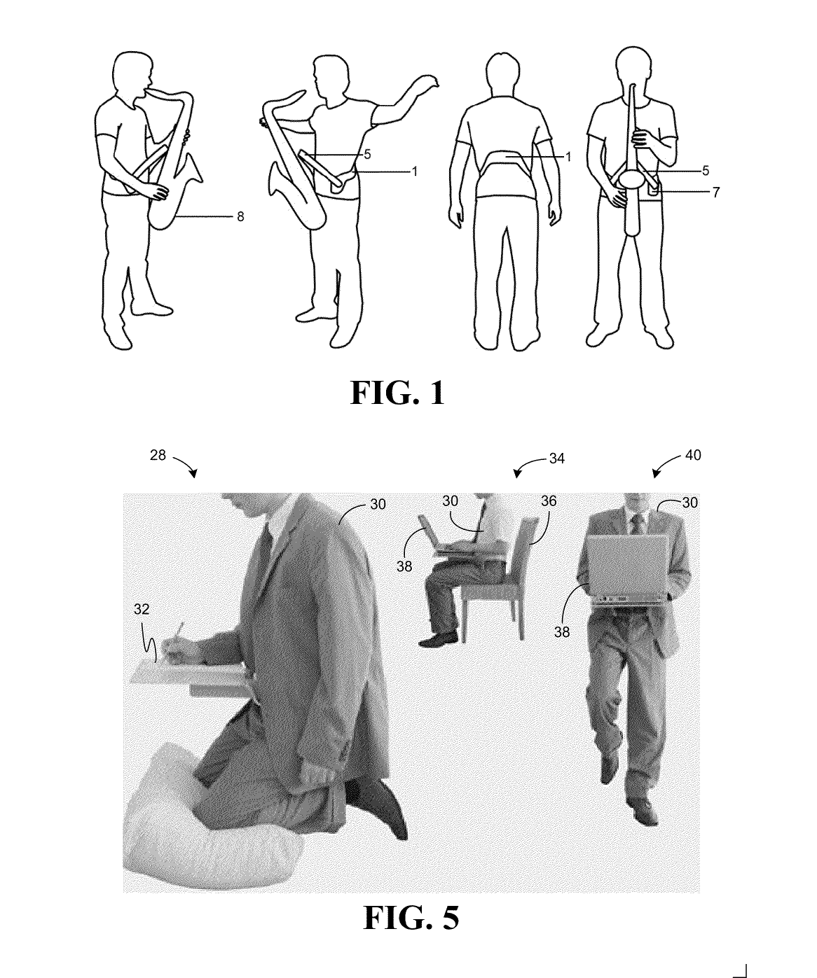

FIG. 1 shows a musician using a support brace/system to support an instrument 8 such as a saxophone. The illustrated support system includes a support brace (e.g., hip brace) 1 mounted on the body. The support/hip brace 1 can be a flat web more or less circular in shape and spanning the greater part of a circle. The illustrated support brace 1 is therefore configured as a loop to be worn around the waist of a user, i.e. wrapped around the small of the back and with its front ends 7 resting on the hips of the musician. Onto this brace 1 there may be mounted a support arm 5 that is attached to the instrument 8.

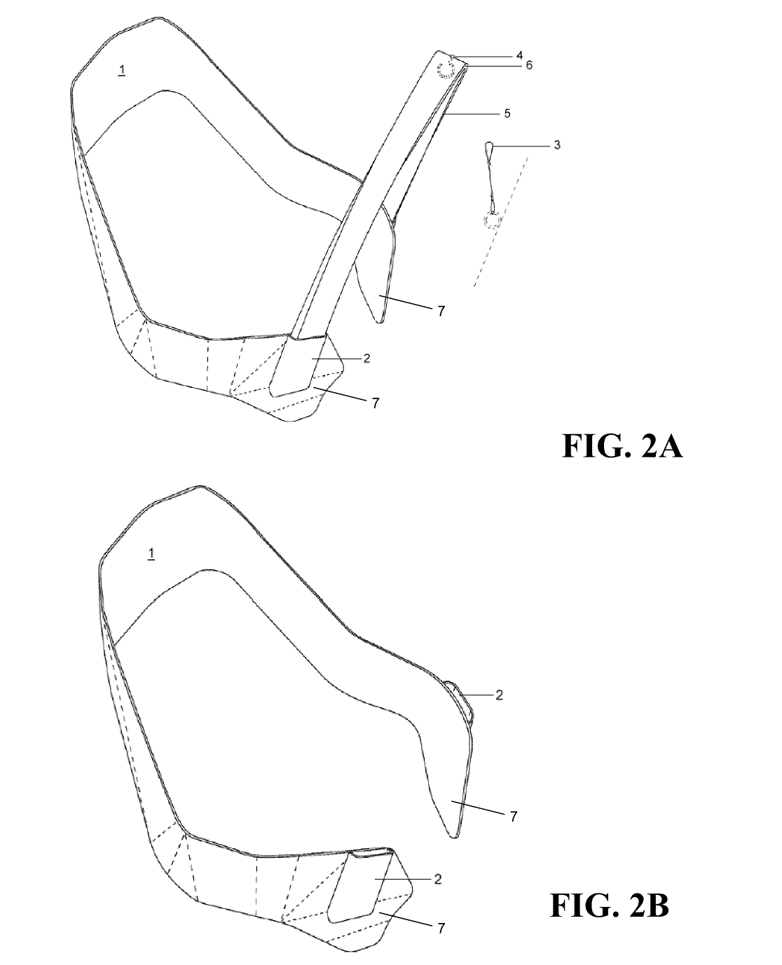

FIGS. 2A and 2B show an example of various components of a support system having a hip brace 1 and a support arm 5. The illustrated hip brace 1 may be made of a rigid yet flexible material, such as a carbon fiber/plastic polymer or any suitable polymer or composite material, or even plywood or light weight metal. In addition, the hip brace 1 can be designed to avoid nagging the body, e.g. the ends 7 may be rounded and slightly turned outward. The illustrated brace 1 includes pockets 2 at the ends 7, which are adapted to receive the removable support arm 5. The arm 5 may be made in any suitable material, as mentioned concerning the brace 1.

The illustrated arm 5 forms an inverted “V” with a hook/metal rivet 4 mounted at the middle section 6 of the V. The hook can be adapted to receive a string 3 attached to the instrument 8 (FIG. 1) and thus support the instrument. Optionally, other arrangements for fastening the instrument to the support arm 5 may be used, such as a tap disposed on the middle section 6 of the arm 5 and adapted to fit into a bracket mounted on the instrument. However, the illustrated arrangement with a string 3 shown in FIG. 2A has the benefit of providing a very flexible connection between the instruments. Moreover, such a configuration may be fitted to any instrument with few if any modifications to the instrument. The string 3 may be tied to any convenient point on the instrument, but it may be particularly effective to tie the string 3 to a point in which the instrument is balanced, possibly near its gravity center, which means that the instrument may be released from the hands without making large movements, as shown in FIG. 1. The string 3 may be made from an elastic material with adequate strength for supporting the instrument. In the example wherein the inventive system is used for supporting a saxophone, a string of Dyneema 30 kg might be used.

For transport, the support arm 5 may be removed from the brace 1. If the components are made of a suitable flexible material, they may be partly collapsed during transport. In particular, the middle section 6 (or bottom as seen from the inside) of the support arm could be made flexible allowing the arm 5 to be folded flat. Thus, the support system might be assembled by coupling the support/hip brace 1 to the plurality of arm ends of the support arm 5, wherein the plurality of arm ends extend from the middle section 6 of the support arm to define an inverted V-shaped geometry. The instrument fastening arrangement may then be coupled to the middle section 6 of the support arm. In one example, each arm end can be inserted into a pocket 2 disposed at a brace end, as already discussed.

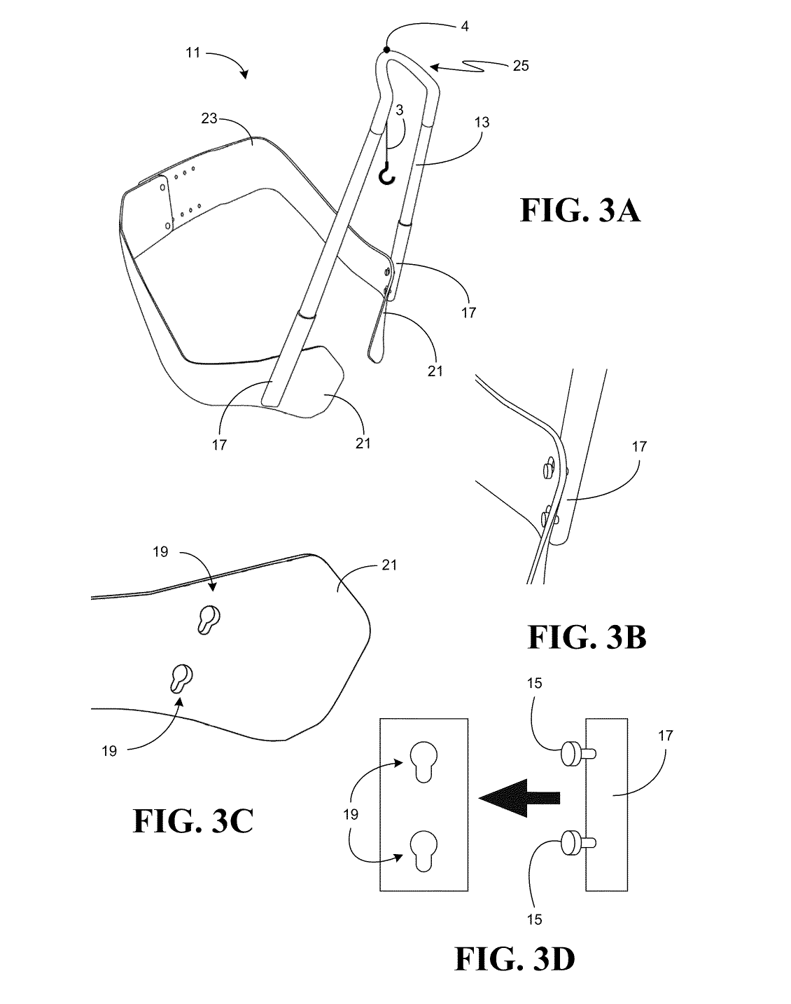

FIGS. 3A-3D demonstrate that other suitable means may be used to mount the support arm onto the hip brace. In particular, the illustrated apparatus 11 has a support arm 13 with bolts 15 (best shown in FIG. 3D) coupled to the arm ends 17, wherein the bolts 15 fit into corresponding holes 19 disposed at the brace ends 21 of a hip brace 23. As in the previous embodiment, the arm ends 17 of the illustrated support arm 13 are configured to extend from a middle section 25 of the support arm 13 to define an inverted V-shaped geometry and the fastening arrangement includes a hook/metal rivet 4 and string 3 coupled to the middle section 25 of the support arm 13.

The support systems described herein may transfer approx two thirds, or more, of the weight of any applicable device, such as a musical instrument, to the lower torso and hips of the human body. This approach is in contrast to the traditional strap and harness systems for instruments in need of weight support, which typically transfer more than two thirds of the weight of the musical instrument to the upper torso, arms, shoulders and neck areas. Accordingly, the illustrated support systems can represent a clear departure from the norm of the industry.

Furthermore, ergonomic benefits of the illustrated support systems may include, but are not limited to:

I) No weight or pressure on the neck allows the airways to open maximally during performance of wind instruments, resulting in less strain and improved performance. A larger air column allows for a more resonant sound production.

II) No weight or pressure on the shoulders reduces strain and fatigue during performance, resulting in longer playing times and lowered risk of injury.

III) Since the instrument is being supported from the hips, below the lower arm of the performer, the performers' hands are no longer using partial energy to stabilize or hold the instrument. The hands are now free to transfer maximal kinetic energy directly to the handling of keyworks, strings etc. on the instrument at hand; something which vastly improves technical facility for the performer, resulting in a more enabled performance situation. Supporting the instrument from the hips can also mean less strain and fatigue during performance, resulting in longer playing times and lowered risk of injury.

IV) No weight or pressure on the torso may allow the airways to open maximally during performance of wind instruments, resulting in less strain and improved performance. A larger air column can enable for a more resonant sound production. It should be noted that it is possible to utilize the illustrated support systems for a number of diverse support tasks across many industries.

While the illustrated support systems may be used as an instrument support system for many musical instruments such as electric guitar and bass, other potential uses may include, but are not limited to: supporting laptop computers for in-field computing, supporting measuring devices for engineering projects, supporting drawing pads for in-field operations, supporting writing & reading for in-field operations, supporting infants in nursing rooms, supporting ambulating sales in sports stadiums, etc. Indeed, a fastening arrangement such as the above-described hook and string configuration might be used to support a wide variety of devices including, but not limited to, fishing rods, weapons, medical slings, gardening tools and metal detectors. Moreover, other fastening arrangements such as trays and/or cribs may be used depending upon the circumstances.

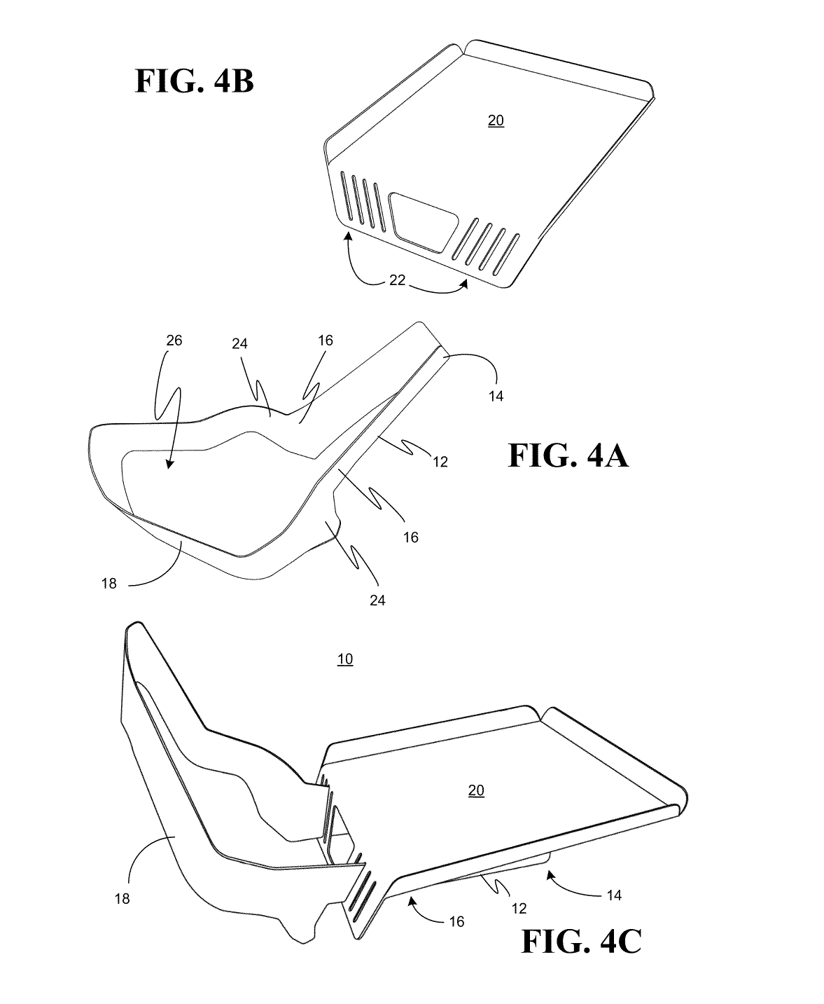

For example, FIGS. 4A-4C show a support system 10 having a support arm 12 with a middle section 14 and a plurality of arm ends 16 configured to extend from the middle section 14 to define an inverted V-shaped geometry. The illustrated support system 10 also includes a hip brace 18 configured to be coupled to the plurality of arm ends 16 and a fastening arrangement configured to be coupled to the middle section 14 of the support arm 12. In the illustrated example, the fastening arrangement includes a tray 20 having edges defining slots/openings 22 through which the middle section 14 of the support arm 12 may be extended in order to secure the tray 20 to the support arm. In particular, the illustrated middle section 14 may be parted so that the arm ends 16 may be extended through corresponding openings 22 in the tray 20, wherein the middle section 14 rests against a bottom surface of the tray 20. Thus, in the illustrated example, a generally V-shaped support structure can be formed via the contact between the arm ends 16 and their respective openings, and the contact between the middle section 14 and the bottom surface of the tray 20.

The hip brace 18 may include a hip section 26 extending between a plurality of brace ends 24 configured to be correspondingly coupled to the plurality of arm ends 16, wherein the hip section 26 is configured to define a partial loop geometry. While the illustrated support system 10 is configured as a single integrated piece, other modular designs may also be used. For example, each brace end 24 could be equipped with a pocket to receive a corresponding arm end 16, or a bolt/hole arrangement might be used, as already discussed. Thus, the tray might be used to support various devices including, but not limited to, food/beverages (e.g., for eating and/or drinking), paint products, writing products, computing systems, medical devices, ticket dispensers, food dispensers, beverage dispensers, and remote controls.

For example, FIG. 5 shows a variety of scenarios in which the tray-equipped support system may be used. In particular, scenario 28 shows an individual 30 supporting a writing product 32 with the hip mounted tray, wherein the individual 30 is able to write on the writing product 32 with one hand free. In scenario 34, the individual 30 sits upright in a chair 36 while typing on a notebook computing system 38 that is supported by the above-described support system. In another scenario 40, the user 30 walks while typing on a notebook computing system 38 that is supported by a tray-equipped support system as described herein.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. An apparatus comprising:
a support arm having a middle section and a plurality of arm ends configured to extend from the middle section to define an inverted V-shaped geometry;
a hip brace configured to be coupled to the plurality of arm ends; and
a fastening arrangement configured to be coupled to the middle section of the support arm.

2. The apparatus of claim 1, wherein the hip brace includes a hip section extending between a plurality of brace ends configured to be correspondingly coupled to the plurality of arm ends, wherein the hip section is configured to define a partial loop geometry.

3. The apparatus of claim 2, wherein the hip brace includes a pocket disposed at each brace end and the pocket is configured to receive an arm end.

4. The apparatus of claim 2, wherein each brace end has a rounded shape and is configured to be angled away from a center of the partial loop geometry.

5. The apparatus of claim 1, wherein the fastening arrangement includes:
a hook configured to be coupled to the middle section of the support arm; and
a string configured to be coupled to the hook.

6. The apparatus of claim 1, wherein the fastening arrangement includes at least one of a tray and a crib.

7. The apparatus of claim 1, further including at least one of a carbon fiber, a polymer and a wood material.

8. An apparatus comprising:
a device;
a support arm having a middle section and a plurality of arm ends configured to extend from the middle section to define an inverted V-shaped geometry;
a hip brace configured to be coupled to the plurality of arm ends; and
a fastening arrangement configured to be coupled to the middle section of the support arm and to the device, wherein if mounted to an individual, the support arm and the hip brace support the device from a hip region of the individual.

9. The apparatus of claim 8, wherein the hip brace includes a hip section extending between a plurality of brace ends configured to be correspondingly coupled to the plurality of arm ends, wherein the hip section is configured to define a partial loop geometry.

10. The apparatus of claim 9, wherein the hip brace includes a pocket disposed at each brace end and the pocket is configured to receive an arm end.

11. The apparatus of claim 9, wherein each brace end has a rounded shape and is configured to be angled away from a center of the partial loop geometry.

12. The apparatus of claim 8, wherein the fastening arrangement includes:
a hook configured to be coupled to the middle section of the support arm; and
a string configured to be coupled to the hook, wherein the device includes at least one of a musical instrument, a fishing rod, a weapon, a medical sling, a gardening tool and a metal detector.

13. The apparatus of claim 8, wherein the fastening arrangement includes a tray and the device includes at least one of a paint product, a writing product, a computing system, a medical device, a ticket dispenser, a food dispenser, a beverage dispenser, and a remote control.

14. The apparatus of claim 8, wherein the fastening arrangement includes a crib.

15. The apparatus of claim 8, further including at least one of a carbon fiber, a polymer and a wood material.

16. A method of assembling an apparatus comprising:
coupling a hip brace to a plurality of arm ends of a support arm, wherein the plurality of arm ends extend from a middle section of the support arm to define an inverted V-shaped geometry; and
coupling a fastening arrangement to the middle section of the support arm.

17. The method of claim 16, wherein the hip brace includes a hip section extending between a plurality of brace ends corresponding to the plurality of arm ends, coupling the hip brace to the plurality of arm ends includes coupling the plurality of brace ends to the plurality of arm ends, and the hip section defines a partial loop geometry.

18. The method of claim 17, wherein coupling the plurality of brace ends to the plurality of arm ends includes inserting each arm end into a pocket disposed at a brace end.

19. The method of claim 16, wherein coupling the fastening arrangement to the middle section of the support arm includes:
coupling a hook to the middle section of the support arm; and
coupling a string to the hook.

20. The method of claim 16, wherein coupling the fastening arrangement to the middle section of the support arm includes coupling a tray to the middle section of the support arm.
